(19) United States
(12) Patent Application Publication
(10) Pub. No.: US 2012/0234249 A1
(43) Pub. Date: Sep. 20, 2012

(54) BIRD FEEDER

(75) Inventor: Martin Robert Gaze, Guildford (GB)

(73) Assignee: GARDMAN LIMITED, Moulton (GB)

(21) Appl. No.: 13/094,191

(22) Filed: Apr. 26, 2011

(30) Foreign Application Priority Data
Mar. 16, 2011 (GB) 1104419.5

(51) Int. Cl. A01K 39/01

(52) U.S. Cl. 119/57.8; 119/51.01

(57) ABSTRACT

A bird feeder comprising a tubular main body having at least one opening in a wall of the main body, and at least one feeder port assembly mounted within the respective opening. Each feeder port assembly comprises a main body part projecting into the tubular main body through the opening, and is magnetically secured directly or indirectly by at least one magnet to the tubular main body. Preferably there are at least two feeder port assemblies mountable within the respective opposing openings, and the opposing feeder port assemblies are magnetically interconnected together by the magnet to hold them in place. There is also described an improved cap assembly with a lid magnetically secured in place. In addition there is further described an improved dual perch arrangement including integral first and second perch members that are spaced laterally and longitudinally from each other.

### CROSS-REFERENCE TO RELATED APPLICATIONS

This application claims foreign priority benefits under 35 U.S.C. §119(a)-(d) to British patent application number GB 1104419.5 filed Mar. 16, 2011 which is incorporated by reference in its entirety.

### TECHNICAL FIELD

The present disclosure relates to bird feeders, in particular to tubular bird feeders, and more specifically tubular bird feeders with feeder ports. It also relates to the lid and perch arrangements which may be incorporated into such tubular bird feeders.

### BACKGROUND

Tubular bird feeders comprising a tubular main body having a top end cap and base closing off the tubular body, and number of feeder ports disposed in the tubular wall are well known, and there are many different detailed arrangements. In particular such tubular feeders for seed typically include feeder port assemblies generally arranged in pairs and fitted into holes in the tubular main body at diametrically opposed positions. The feeder port assemblies extend into and across the interior of the tubular body. The opposed feeder port assemblies are typically connected and held together by for example nut and bolt connections to locate and mount the feeder port assemblies in the holes and to the tubular main body. The feeder port assemblies as well as reinforcing and providing a mounting for projecting perches which project outwardly from the feed port assembly and tubular feeder also extend across the tubular body and form a deflector plate or baffle located above the feeder port aperture preventing excessive quantities of seed within the tubular main body from falling out of the feeder port while still allowing birds to readily access the feed within the tubular body through the open feeder port.

Connecting the pairs of feeder ports by the typical nut and bolt connection is however time consuming and relatively awkward. It has therefore been proposed in GB2415350, U.S. Pat. No. 6,863,024 and U.S. Pat. No. 4,356,793 to interconnect opposing feeder port assemblies by means of a snap fit connection in which an end of one of the feeder port assembly fits into and connects with an opposing end of an opposing feed port assembly connecting the feeder port assemblies together. Such arrangements as described are easier to assemble than a nut and bolt configuration.

In another proposed arrangement as for example described in GB2451062 and GB2467628 it has been proposed to provide feeder port assemblies having distal ends within the tubular member which overlap and which include a generally axial aperture through which an axial pin extends to lock the feed ports together. This arrangement, by removing the pin, allows the feeder ports to be disconnected and subsequently removed from the tubular members for cleaning However in GB2451060 it is required to provide two different handed feeder port assemblies of different constructions to one another which will then be fitted together. This increases manufacturing costs. While this is addressed in GB2467628, both of these arrangements also require the additional axial pin and for this to be aligned and fitted carefully into the assembled feeder ports which can be difficult in particular with very long tubular feeders and adds to the number of components and costs of the bird feeder.

In yet other tubular bird feeders the feeder ports may be individually mounted and fitted into apertures within the tubular main body as for example proposed in US2005/263085 and US2007/0227453. Such arrangements are however relatively complex involving a large number of individual components and are relatively complex to assembly.

Therefore in one aspect of the present disclosure it is desirable to provide an improved bird feeder arrangement with in particular feeder port assemblies which are quickly and easily interconnected and which can be disconnected to allow disassembly of the bird feeder. This is in particular important for feeder hygiene since diseases may be transmitted at bird feeders increasing bird mortality.

Most feeder port assemblies also include a relatively simple perch comprising a rod projecting generally radially outwards from the tubular assembly and tubular main body. Such single rod perches are shown for example in the prior patent documents GB2476628, GB2451062, U.S. Pat. No. 4,356,793 and US2005/0263085 mentioned above. Other perch configurations are however known and in US 2007/0227453 a two part perch arrangement comprising two separate elements provides a dual A shaped perch. In this arrangement two cross members are spaced at different distances from the tubular member is proposed. This arrangement advantageously provides both a perch perpendicular to the axis of the feeder port allowing a bird to more easily perch and access the feeder port while the dual perches at different distances of the feeder port accommodate birds of different sizes. It has also been proposed in GB 2415593 to provide a pivoted T-shaped perch which pivots upwards. The pivoting perch allows the perch to be pivoted upwards parallel to the sides of the tubular member for ease of storage and transportation. Many other perch arrangements are also known and in particular the bird feeder may include no projecting perch member with birds simply hanging onto the edge of the feeder ports. It is however, in another aspect of the invention desirable to provide a further improved or alternative perch arrangement in particular for such a tubular bird feeder.

The top end cap of the bird feeder is usually removable in order to allow filling of the bird feeder and the inside of the tubular main body with the bird seed or other feed. The top end cap is preferably relatively firmly secured to the main tubular member to close off the top end and prevent other animals for example squirrels from removing the top end cap and eating the food. In addition the top end cap must be relatively firmly secured to prevent it from being inadvertently dislodged in windy conditions which would then let the top of the bird feeder open allowing rain to spoil the bird seed within and/or the bird seed to be spilt. While existing push cap arrangements in which the top cap is generally held in place by an interference fit are generally acceptable to prevent inadvertent dislodgement of the top cap they may be difficult to remove. In particular they often require two hands to remove the end cap. Conversely any more loosely fitting cap which may be easier to remove, may be easily dislodged. It is therefore in yet a further aspect of the invention desirable to provide a bird feeder with an improved cap arrangement.

### SUMMARY

Overall and more generally it is desirable to provide an improved bird feeder which addresses the above described problem and/or provides an improvement to existing bird feeder arrangements.

According to the present disclosure there is therefore provided a bird feeder as variously described in the accompanying claims. There is also provided a perch assembly as further described in the accompanying claims.

In an embodiment of one aspect the present disclosure there is provided a bird feeder comprising a, preferably cylindrical, tubular main body having at least one opening in a wall of the main tubular body. At least one feeder port assembly is mounted within the respective opening. Each feeder port assembly comprises a main body part projecting into the tubular main body through the opening. The feeder port assembly is magnetically secured directly or indirectly by at least one magnet to the tubular main body.

The magnet attachment of the feeder port assembly more easily attached the feeder port assembly making assembly easier and simpler with fewer components, and also advantageously allows the feeder port assembly to be easily selectively removed by simply pulling against the magnetic connection.

Preferably there are at least two feeder port assemblies mountable within the respective opposing openings. The two opposing feeder port assemblies are magnetically interconnected by the at least one magnet. Moreover preferably each feeder port assembly has an end arranged to abut against and interconnect to the main body part of an opposing feeder port assembly. At least one magnet is preferably located in the end of the feeder port assembly main body, more preferably there is at least one magnet in each feeder port assembly arranged to attract an opposing magnet in other opposing feeder port assembly.

The openings and opposing feeder port assemblies may be diametrically opposed about the tubular main body.

Preferably the bird feeder includes a plurality of substantially identical feeder port assemblies. Such identical feeder port assemblies make manufacture and assembly simpler.

The feeder port assembly preferably comprises a collar member defining a feed port opening, and the main body part extends and projects from the collar member. The feeder port assembly preferably comprises a baffle member for deflecting the contents within the main tubular body from falling out from the opening. The feeder port assemblies may further comprises a projecting perch.

The bird feeder may further comprise at least one end cap assembly closing off at least one end of the tubular main body.

In a particular embodiment of the present disclosure there is provided a bird feeder comprising a tubular main body having at least two generally opposing openings in a wall of the main tubular body, and at least two feeder port assemblies. The at least two feeder port assemblies are mounted within the respective opposing openings. Each feeder port assembly comprises a main body part projecting into the tubular main body through the opening and has an end arranged to abut against and interconnect to the main body part of an opposing feeder port assembly. The two opposing feeder port assemblies are when fitted to the bird feeder magnetically interconnected by at least one magnet.

In an embodiment of another aspect of the present disclosure there is provided a bird feeder comprising a tubular main body and a cap assembly closing of at least one end of the tubular body. The cap assembly comprises a lid and at least one magnet, preferably mounted on the lid, magnetically connecting and at least partially securing the lid to the end of the tubular main body.

Magnetically securing the lid secures it in both a simple and robust manner preventing it from being knocked off or removed by for example a squirrel, while also allowing a user to easily remove the cap when required for example to fill the bird feeder.

Preferably there is a pair of corresponding magnets arranged to attract one another.

Preferably the lid is hingedly connected to the main tubular body by a hinge. This retains the lid preventing it from being lost and allows the lid to be easily opened for example one handedly. Alternatively the lid is removably mounted to the end of the tubular main body.

The cap assembly may comprise a frame portion mounted to the tubular main body and the lid is connected to the frame portion. The frame portion may furthermore comprise and define a wide opening having inwardly tapering sides to act as a funnel to assist in directing feed into the tubular main body to facilitate efficient filling and minimize spillage and waste.

In an embodiment of yet another aspect of the present disclosure there is provided a perch for a bird feeder comprising a first projecting member, and first perch and second perch members integral with the first projecting member and disposed along the first projecting member and projecting therefrom at an angle thereto. The second perch member is spaced from the first perch member along the first projecting member. The first projecting member has an attachment end and mounting attachable to the bird feeder such that the first member extends and projects from the bird feeder when attached thereto. The first projecting member is also angled from the attachment end and mounting such that when mounted to a bird feeder the projecting member is angled and non perpendicular to the bird feeder and the first and second perch members are spaced both laterally and longitudinally from each other and the attachment end of the first member.

This provides a simple dual perch assembly that can be utilized by birds of different sizes providing perches at different distances and heights from the feeder main body and feed ports, and can be contrasted with more complex multi part dual perches previously provided.

The first projecting member is preferably curved along its length from its attachment end to the first and second perch members. The first projecting member may have an increasing curvature along at least part of its length.

The first and second perch members preferably project transversely to the first projecting member. The first and second perch members may extend from either lateral side of the first projecting member.

The perch assembly may further comprise a second projecting member with first and second perch members extending therebetween. The first and second projecting members preferably project at a diverging angle to each other diverging from their attachment ends.

The features of the various aspects of the present disclosure may also be combined and variously utilized together in a number of varied different combinations, and in combination or on their own in yet further variations and embodiments and further aspects of the present disclosure.

Embodiments of the present disclosure will now be described by way of example only with reference to the below figures.

### BRIEF DESCRIPTION OF THE DRAWINGS

FIG. 1 is a schematic illustration of a bird feeder in accordance with an embodiment of the present disclosure;

FIG. 2 is an exploded schematic illustration of the bird feeder shown in FIG. 1;

FIG. 3 is a more detailed exploded perspective view of the top and top cap assembly of the bird feeder shown in FIG. 1;

FIG. 4 is an exploded detailed view of the bottom of the bird feeder shown in FIG. 1 showing the bottom of the bird feeder and base;

FIGS. 5a to 5e are more detailed views of the perch which is connected to the bird feeder ports of the bird feeder shown in FIG. 1, with FIG. 5a comprising a schematic plan view, FIG. 5b comprising a front view, FIG. 5c comprising a side view, FIG. 5d comprising a rear view, and FIG. 5e comprising a cross sectional view on section A-A shown in FIG. 5a.

FIG. 6 is a schematic illustration of a bird feeder in accordance with an alternative version of the present disclosure and in particular including an alternative perch; and

FIG. 7 is an exploded perspective view of the bird feeder shown in FIG. 6.

### DETAILED DESCRIPTION

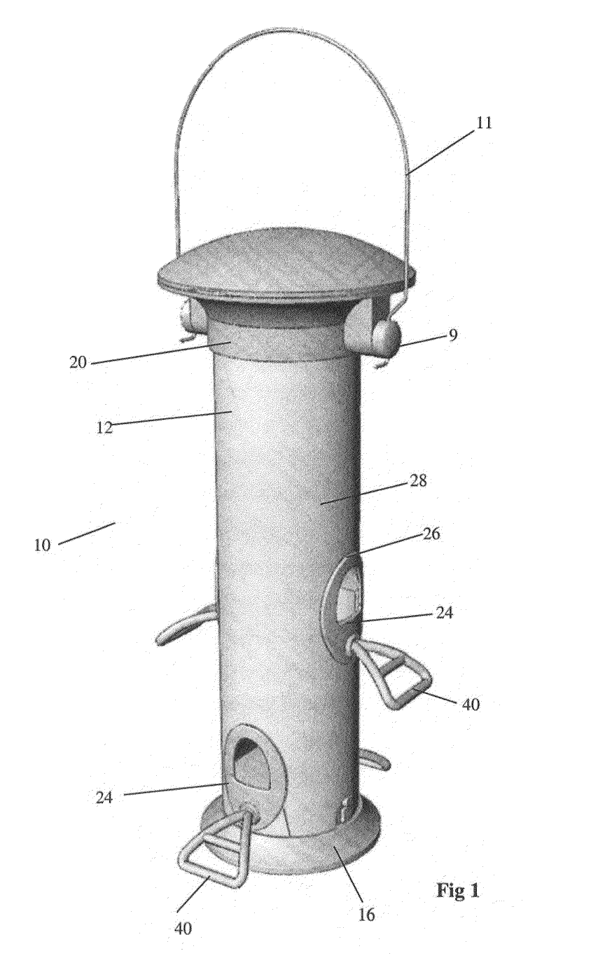

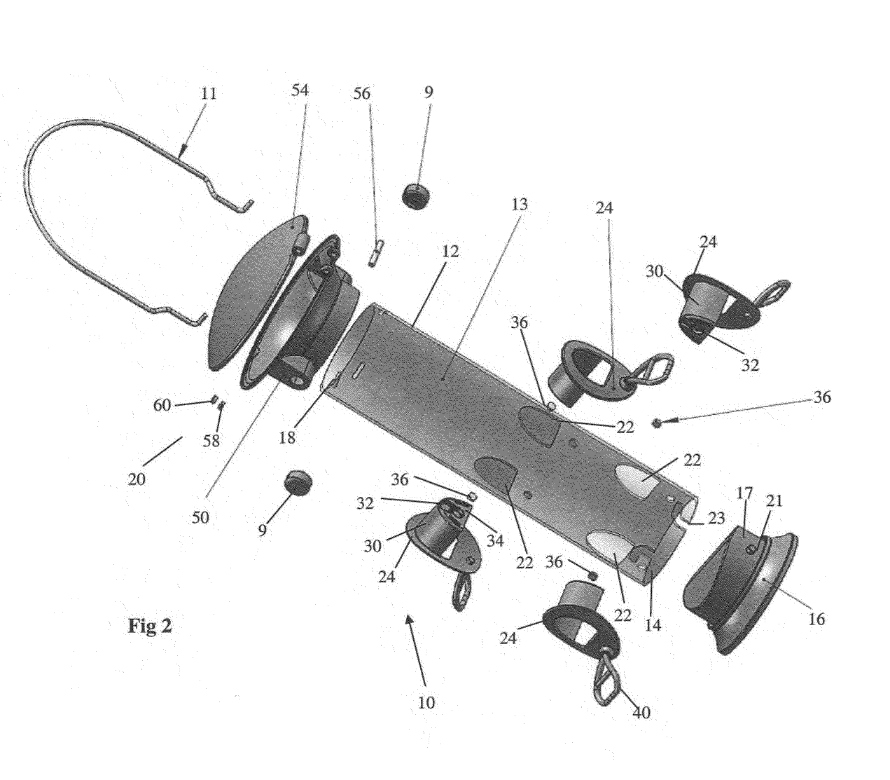

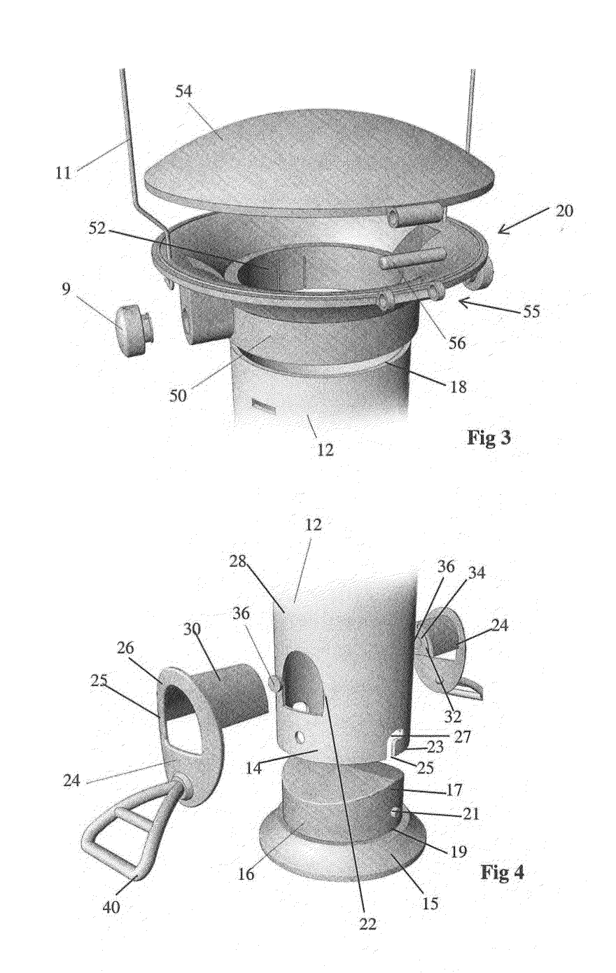

Referring to FIGS. 1 to 4 the tubular type bird feeder 10 of an embodiment of the present disclosure comprises a tubular main body 12 having a bottom end 14 closed off by a base cap 16 and a top end closed off by a top cap assembly 20. A handle 11 is preferably attached to the top cap assembly 20 to enable the bird feeder 10 to be hung from a suitable support. The handle 11 is in particular pivotally attached by pivot pins 9 located in ends of the handle 11 and which are mounted into the top cap assembly 20.

The tubular main body 12 in this particular embodiment is preferably cylindrical having a circular cross section. In other embodiments however it may have other shapes for example having a square, hexagonal, octagonal or hexagonal or ellipsoidal cross section for example. The tubular main body 12 is preferably formed from a transparent plastic material for example PVC or polycarbonate (Perspex) although in other embodiments may be made from metal or other materials. The tubular main body 12 defines a hollow interior 13 for use storing bird feed or seed.

At least one opening, and preferably a plurality of openings 22 or ports are defined in the wall of the tubular main body 12. Preferably these openings 22 are arranged in opposing pairs facing each other diametrically opposed on diametrically opposite sides of the tubular main body. Furthermore, pairs and sets of the openings 22 are preferably disposed along the axial length of the tubular main body with the openings at different axial positions along the tubular main body at different circumferential positions around the tubular main body 12 such that the openings 22 are staggered both circumferentially and axially about the tubular main body 12. The openings 22 are preferably however disposed towards one end and in particular the lower end 14 of the tubular main body.

A plurality of corresponding feeder port assemblies 24 are mounted and fitted to the respective opening ports 22 in the tubular main body 12. The feeder assemblies 24 each comprise a collar flange 26 shaped to abut against the exterior surface 28 of the tubular main body 12 around the opening 22. The collar flange 26 extends outwards from the outer edge of the feeder port 22. A feed port opening 25 preferably generally corresponding to the opening 22 in the tubular main body 12 is defined in the collar flange 26 allowing access through this feed port 25 into the inside 13 of the tubular main body 12 and the bird feed located therein. While the feed port opening 25 in the feeder port assembly 24 preferably generally corresponds to that of the opening 22 in other embodiments it may have a different shape and size. A main body portion 30 of the feeder port assembly 24 extends from the collar flange 26 and is arranged to fit into and within the opening 22. In particular the main body 30 is arranged to abut against the edge of the opening 22 to thereby locate the feeder port assembly 24. The main body portion 30 preferably extends into the interior 13 of the tubular main body 12 when the feeder port assembly 24 is fitted and preferably extends half way across the diameter of the tubular main body 12 such that a distal end and end face 32 of the tubular main body 12 and feeder port assembly 24 abuts against a corresponding end 32 of an opposing feeder port 24 fitted into an opposing opening 22. The main body 30 of the feeder port assembly 24 effectively comprises an arcuate cowl extending around and over an upper portion of the feed port 25 and opening 22. This main body 30 and cowl prevents seed from within the interior 13 of the tubular main body 12 from directly falling out of the feed port 22. The arcuate cowl and main body 30 is however open towards a lower portion to allow access through the opening 25 to the interior of the tubular main body 12.

Mounted and preferably fixed into the end face 32 preferably within a small recess 34 is a magnet 36. The magnets 36 of opposing feeder port assemblies 24 are orientated and arranged such that when opposing feed ports 24 are fitted into opposing ports 22 they attract each other and thereby connect and join together the abutting ends 32 of opposing feed ports 24 and thereby hold opposing feed port assemblies 24 together. As a result the feeder ports 24 are secured and held in position within the openings 22 in the tubular main body 12 and to the tubular main body 12 of the bird feeder 10 by this magnetic attraction force between these magnets 36. The feeder port assemblies 24 can however be selectively removed and pulled from the tubular main body 12 by prying or otherwise moving the collar flange 26 away from the outer surface 28 of the tubular main body 12 and pulling the opposing feed port assemblies 24 apart. This then enables the bird feeder 10 and in particular inside of the tubular main body 12 and the feeder port assemblies 24 themselves to be cleaned. The magnets 36 may be retained within the ends 32 of the feeder port assemblies 24 by adhesive and/or by an interference fit or other suitable means. If the feeder port assembly 24, or at least end 32, is ferrous then the magnet 36 will be held in place itself by magnetic attraction.

While it is preferable that each feeder port assembly 24 includes a respective magnet 36 to both improve the magnetic force and attraction between the opposing feeder ports 24 and also to simplify manufacture in other embodiments only one of the pair of opposite feeder port assemblies 24 may include a magnet 36 with this magnet 36 either directly attracting the opposing end 32 of an opposing feeder port assembly 24 if this is made from a ferrous material and/or being attracted to a ferrous plate (not shown) which may be fitted to the end 32 of the feeder port assembly 24. In yet further alternative embodiments each of the feeder port assemblies 24 may include two or more magnets 36 mounted in the ends 32, such magnets in particular may be oppositely directly directed and spaced in particular laterally on left and right sides of the end 32 of the feeder port assemblies 24. This would then enable identical feeder port assembles 24 to be manufactured and fitted with the oppositely directed left and right hand side magnets abutting against the opposite and opposing right and left magnets of the opposing feeder port assembly 24 being oppositely directed to provide the magnetic attraction force between the magnets 36 and feed port assemblies 24. Such identical feeder port assemblies 24 with identically directed magnets would simplify manufacture and avoid the need to produce two separate sets of feeder port assemblies 24 with respective opposing directed magnets. In yet further alternative arrangements a single magnet 36 could simply be disposed sandwiched between pairs of opposing feeder ports 24, with this single magnet 36 either directly attracting the ends 32 of both the opposing feeder port assemblies 24 and/or being attracted to metallic plates fitted to the ends 32 of the opposing feed port assemblies 24. The single magnet 36 sandwiched between the opposing ends 32 of opposing feeder port assemblies 24 effectively joining them both together.

A perch assembly 40 is mounted to and extends from the feeder port assembly, and in particular flange 26 from which a bird may perch and rest to feed from the bird feeder and through the opening 25 in the feeder port assembly 24. The perch 40 is preferably located towards a bottom and below the feed port aperture 25 and will be described in more detail below.

The feeder port assembly 24 is preferably made of a cast metal, for example die cast zinc or aluminum although other embodiments may be made from other materials in particular plastic. As a result separate magnets 36 or ferrous plates are needed. If however it is made from a ferrous metal, for example steel then only one magnet may be needed with the magnets directly attracted to the feeder port assembly 24. Preferably the feeder port assembly 24 is also an integral one piece element with the collar flanges 26 and main body 30 being unitary and integral and to which the assembly 40 is then subsequently attached. In other embodiments however the feeder port assembly 24 may be made up of a number of separate parts assembled together.

The base cap 16 is generally conventional and comprises an insert portion 17 which is fitted into the end 14 of the tubular main body 12 to close off and block the end 14 of the tubular main body 12. An end flange 15 with a shoulder 19 which abuts against the end 14 of the tubular main body 12 to locate the end cap 16 and insert portion 17 within the end 14 of the main body 12. The end cap 16 may be held in place by any suitable means. In this embodiment it is secured to the main body 12 by a pair of radially projecting spigots 21, projecting from the insert portion 17, which are located within a hook shaped channel 23 formed in the end 14 of the tubular main body 12. The spigots 21 are fitted into the opening straight portion 25 of the hook shaped channels 23 with the end cap assembly 16 then being rotated to move the spigots 21 into a circumferentially extending portion 27 of the hook shaped channel 23 to thereby retain the end cap 16 axially in the end 14 of the tubular main body 12. Alternatively to the base cap assembly 16 the tubular main body 12 may include an integral base integral and/or permanently fixed to the end 14 of the tubular main body 12.

The top cap assembly 20 comprises a main collar portion 50 which is adapted to be fitted to and mounted upon the top end 18 of the tubular end body 12, preferably permanently by an adhesive, interference fit or other suitable attachment. The main collar portion 15 defines and surrounds an opening 52 therethrough preferably corresponding to the open end 18 of the tubular main body 12 and into the interior 13 of the main body 12. The top cap assembly 20 may further comprises inwardly tapering sides (not shown) around and defining the opening 52 which would taper to act as a funnel to assist in directing feed into the tubular main body 12 to facilitate efficient filling and minimize spillage and waste. The cap assembly 20 further comprises a lid 54 which is arranged to close off and cover the opening 52 within the collar 50 and the top cap assembly 20. The lid 54 in this particular embodiment is preferably hingedly 55 mounted to the collar 50 by a pivot and pivot pin 56 disposed on one side and edge of the lid 54 and collar 50. This allows the lid 54 to pivot about the pivot pin 56 and edge to allow access to the opening 52 through the cap 20 and into the interior 13 of the tubular main body 12.

In order to keep the lid 54 in the closed position as shown in FIG. 1, a suitable latch arrangement is provided. In particular and in accordance with an aspect of the present disclosure this latch arrangement comprises a magnetic latch comprising a pair of opposing magnets 58,60 one mounted to the lid 54 and the other mounted oppositely facingly to the collar 50 preferably on the opposite side of the lid 54 to the hinge connection 55. The magnets 58, 60 are arranged to be attracted to each other and thereby attract the lid towards the collar 50 and keep it in a closed position. While the lid 54 is held in the closed position by the magnetic latch this can be released by a user lifting the lid and overcoming the attraction force in order to access the interior 13 of the tubular main body 12 and bird feeder 10 for example to fill it with bird seed. This magnetic arrangement thereby provides a simple and easy way to secure the lid 54 and top cap 20 of the bird feeder whilst allowing the top cap and lid to be opened for filling. This magnetic attachment and securement of an end cap of the tubular main body 12 is a further separate aspect of the present disclosure which may be employed separately on its own.

In other embodiments only one magnet may be provided on the lid 54 or collar 50 with this magnet then being directly attracted to the opposing lid 54 or collar 50 if it is made of a ferrous material and/or being attracted to a metal plate mounted on the lid 54 or collar 50. Further magnets may also be provided to additionally secure the lid 54 to the collar 50.

In addition it will also be appreciated that the hinge connection 55 may in other embodiments be omitted and for example replaced by a further magnetic latch arrangement such that the lid 54 is entirely held to the collar 50 by magnets and a magnetic attraction. A hinge connection 55 and/or at least some retention of the lid 54 to the collar 50 and bird feeder 10 is however preferred in order to prevent the lid 54 from being fully detached and perhaps lost from the remainder of the bird feeder 10. A hinge connection 55 also allows the lid to be easily opened and flipped for example by using only one hand whilst the magnetic hatch when it is closed secures the lid 54 against for example opening by a squirrel or by the wind. In yet a further arrangement the collar 50 may be emitted in its entirety and the lid 54 directly mounted to the end 18 of the tubular main body 12.

The top cap assembly 20 is preferably cast and in particular die cast from zinc or aluminum it may however be made from other materials, for example plastic.

The top cap assembly 20 arrangement comprising a lid 54 secured by a magnetic latch arrangement could also be used in place of the base assembly 16 to close off a base end 14 of the bird feeder 10. This would then more easily allow bird seed within the interior 13 of the tubular main body 12 to be easily removed from the bottom of the tubular main body 12 if required, by more easily opening the base 16 without needing it to be removed from the tubular main body 12.

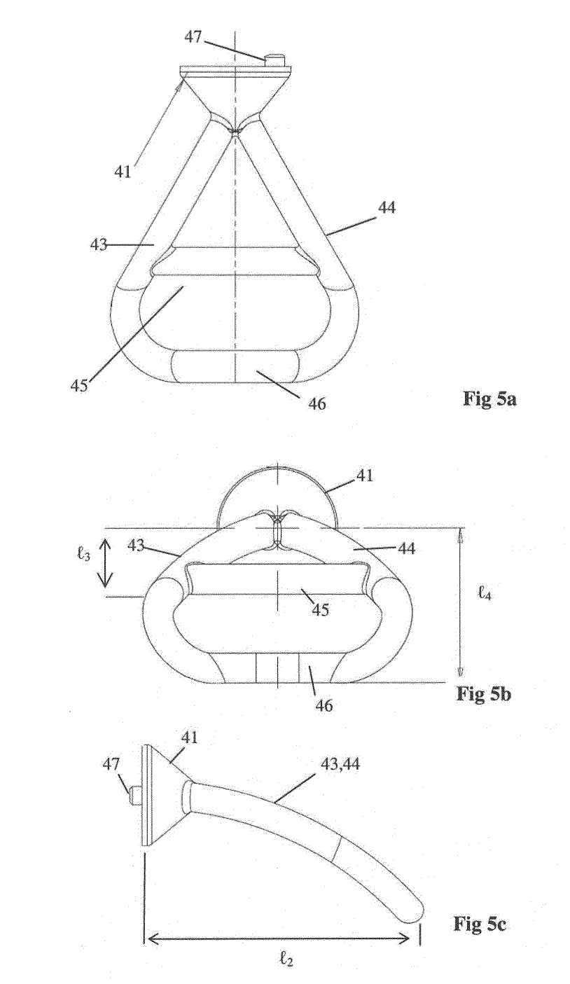

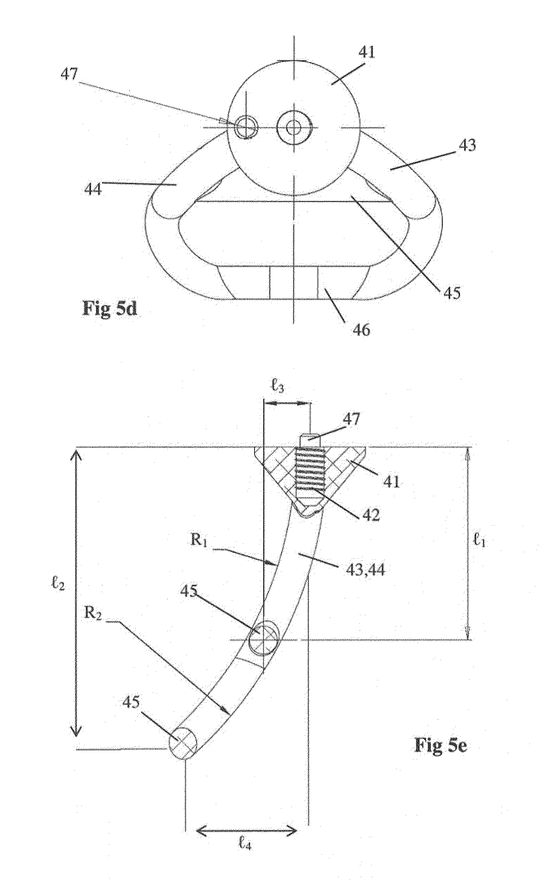

The perch assembly 40 is shown in more detail in FIGS. 5a to 5e. The perch assembly 40 comprises a mounting boss 41 having in this case an internally threaded bore 42 (see FIG. 5e) to which a bolt (not shown) extending through an aperture in the collar flange 26 of the feeder port assembly 24 may be suitably engaged to attach the perch assembly 40 to the feeder port 24. A spigot 47 laterally offset from the threaded bore 42 and projecting from the mounting boss 41 is located in a corresponding aperture or recess (not shown) in the collar flange 26 to additionally locate the perch assembly 40 and prevent it from rotating about the bolt. In alternative embodiments the perch assembly 40 may however be integral with the feeder port assembly 24, or directly attached to the tubular main body 12 separately to the feeder port assembly 24 although this is less preferred.

The perch assembly 40 further comprises a pair of curved projecting members or arms 43, 44 which project and extend from the mounting boss 41. These are curved along their length such that when fitted to the feeder port assembly 24 and bird feeder 10, they are curved in a downwards direction and away from the feed port aperture 25. The arms 43, 44 preferably as shown also diverge as they project from the mounting boss 41. Part way along the length of the projecting arms 43, 44 and extending between and interconnecting the arms 43, 44 is a first, intermediate perch member 45 which extends an angle from the projecting arms 43, 44 such that when the perch 40 is fitted to the bird feeder 10 the first perch member extends in a cross direction parallel to the exterior surface 28 of the tubular main body 12. Spaced from this first perch member 45 and further along the projecting arms 43, 44 and preferably in this case at the distal end of the projecting arms 43, 44 there is a second perch member 46 parallel to the first perch member 45 and spaced from it. The second perch member 46 similarly connects and extends between the projecting arms 43, 44. Due to the pronounced curved nature of the arms 43,44 the first and second perch members 45,46 are thereby spaced both at different lateral distances L1 and L2 from the mounting boss 41 and feeder port assembly 24 and exterior 28 of the tubular main body 12, and at different vertical distances L3 and L4 from the mounting boss 41 and in particular feed aperture 25 of the feed port assembly 24. This thereby provides a dual perch assembly 40 which can be used by birds of differing sizes with smaller birds being able to readily utilize the first perch member 45 closer both laterally and vertically to the feed opening 25 and larger birds using the second perch assembly 46 spaced further away from the feed port opening 25. This perch assembly can also be contrasted with multi perch assemblies and is easier and simpler to assemble. It will also be appreciated that in another embodiment further perch members extending between the projecting arms 43, 44 could be provided to provide further perches for birds of different sizes.

The curved projecting members or arms 43, 44 may not be curved along their entire length or have a constant curvature. In particular they may have a varying and preferably more pronounced and increasing curvature beyond the first perch member 45 so as to increase the vertical separation between the first and second perch members 45, 46. For example the radius of curvature R1 of a first portion of the projecting arms 43, 44 may be greater than the radius of curvature R2 of a second portion. In further alternative embodiments the curved projecting members or arms 43, 44 may be replaced with straight projecting members which are mounted at a pronounced downward angle. The angle of such straight angled projecting members or arms may also increase beyond the first perch member.

The perch assembly 40 is in particular an integral one piece structure and maybe preferably moulded or cast, for example die cast, from zinc or in alternate embodiments plastic.

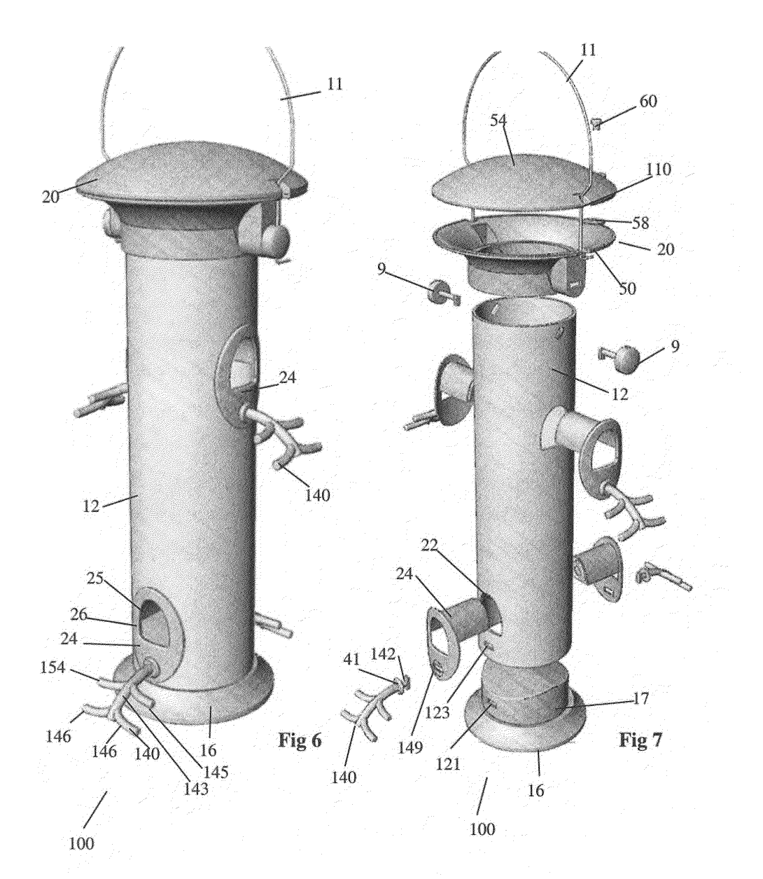

An alternative bird feeder arrangement is shown in FIGS. 6 and 7, this bird feeder 100 is generally similar to the bird feeder 10 shown in FIGS. 1 to 4 and only the main differences will be described in detail with also like reference numerals being used for corresponding features.

This bird feeder 100 comprises a tubular main body 12 having a bottom end closed off by a base end cap 16 and a top end closed off by a top cap assembly 20. The tubular main body 12 includes a plurality of apertures 22 into which are fitted feeder port assemblies 24. As shown in this case, two pairs of feeder port assemblies 24 are provided located towards opposite ends of the tubular main body 12. The feeder port assemblies 24 are similarly held together by a magnetic connection and magnet disposed in the ends 32 of the feed port assemblies 24.

In this embodiment and bird feeder 100, the perch assemblies 140 attached to the feed port assemblies 24 however differ from those shown in FIGS. 1 to 4. These perch assemblies 140 comprise a single curved projecting arm 143 generally centrally located. Part way along the length of this projected member 143 and extending therefrom are a first pair of first perch members 145 which oppositely extend generally perpendicular from opposite lateral sides of the projecting member 143. Towards a distal end of the projecting member 143 is a second pair of perch members 146 extending perpendicular to the projecting member 143 and generally parallel to the first pair of perch embers 145. The first and second pairs of perch members 145,146 are similarly spaced at different distances laterally away from the outside 28 of the tubular main body 12 and due to the curved nature of the projecting member 143 at different vertical distances from the feed port 25 to be used by birds of different sizes. It will be appreciated that in another embodiment further perch members extending between the projecting arms 43, 44 could be provided to provide further perches for birds of different sizes.

The perch assembly 140 of this embodiment is also slightly differently mounted to the feed port assembly, in this particular case a T-shaped spigot 142 projects from the mounting boss 41. The end of the T shape spigot 142 is located in a slot 149 in the feeder port assembly 24 and in particular collar flange 26 of the feed port assembly 24. In this particular case the slot 149 is horizontally arranged and the T-shaped spigot 142 is vertically arranged when the perch 140 is in the fitted position. To fit the perch 140 it is rotated such that the T-shaped spigot 142 is horizontal and can be fitted into the horizontal slot 149. The perch 140 is then rotated rotating the T-shaped spigot 142 to a vertical position when located behind the collar flange 26 with ends of the T-shaped spigot 142 resting above and below the slot 149 and thereby retaining the perch 140 in position.

The base cap assembly 16 is also slightly differently located and fixed to the end of the tubular main body 12. In this particular case a further horizontal slot 121 is provided in the insert portion 17 of the base assembly 17. This slot 121 is aligned with a further horizontal slot 123 in the end of the tubular main body 12 when the insert 17 is fitted into the end of the tubular main body 12 and cap assembly 16 fitted. These slots 121, 123 are also aligned with the horizontal slot 149 of the lower feed port assembly, with then the T-shaped spigot 142 of the perch assembly 140 extending through all of the slots 149, 123, 121 and then engaging behind top and bottom edges of slot 121 in the base cap assembly 16 to thereby retain the base cap assembly 16 to the bottom of the tubular member 12 and also mount the perch 140.

The top cap assembly 20 in this embodiment also differs slightly from that of the embodiments shown in FIGS. 1 to 4. In this case the lid 54 is differently connected to the collar 50 without a magnetic connection. In this embodiment the lid 54 is held in place by a vertical hinge pin 60 an end of which locates into a corresponding recess 58 in the collar, with the lid 54 pivoting horizontally about this pin 60 to an open position. The lid 54 additionally preferably includes two slots 110 in its periphery within which the handle 11 is located to thereby lock the lid 54 on the cap assembly 20. When the handle 11 is pushed down vertically the narrowed portions of the handle disengage from the slots 110 which then allows the handle 11 to pivot downwards about the fixing pivots 9 and out of the way of the lid 54 allowing it to be pivoted horizontally about pivot pin 60. With the lid 54 closed the handle 11 can then be pivoted and lifted upwards with the narrowed ends of the handle then locating in the slots to lock the lid 54 in the closed position.

In other embodiments different lid arrangements may be used, and in particular different magnetic lid arrangements. For example the top cap assembly 20 may include a lid 54 that is separate to the collar 50 and is not hingedly connected. Instead the lid 54 is simply held in place by a magnetic connection and magnets mounted to the lid 54 and collar 50 respectively. The two slots 110 in the periphery of the lid 54 within which the handle 11 is located thereby then locate the lid 54 on the cap assembly 20, with the magnets keeping it in place vertically and resting on the collar 50. Other arrangements are also possible.

While in both of these bird feeder arrangements 10, 100 the feed port assemblies 24 and openings 22 are oppositely directed and diametrically opposed other arrangements are possible. For example the feed port openings 22 may not be diametrically aligned and may be offset from a diameter of the tubular main body 12 in particular if the tubular main body 12 is non-cylindrical. The opposing feed port assemblies 24 may also be arranged at an angle to each other and additional feed port assemblies 24 may abut and join together. For example three feed port assemblies 24 may abut and be joined in a Y configuration 120° to each other, or four feed port assemblies may abut and be joined in a cross configuration at 90° to each other.

In yet further alternative arrangements the feed port assemblies 24 may not abut opposing feed port assemblies 24, although the opposing arrangement described above is generally preferred. Instead an individual feed port assembly 24 may be individually mounted and secured to the tubular member 12 and openings by suitable magnetic connection. For example a magnet could be mounted in the rear face of the collar flange 26 and magnetically be attracted to the outside of the tubular main body 12 to secure the collar flange 26 and thereby feed port assembly 24 to the tubular main body 12, in particular if the tubular body 12 is made of a ferrous material. Alternatively a magnet or ferrous plate could be disposed on the inside of the tubular main body 12 opposing the collar flange 26 and to which a magnetic and/or plate on the flange is attracted with a portion of the main body 12 being sandwiched between such a plate and the collar flange 26 to thereby secure the feeder port assembly 24. Various other arrangements of magnetically attaching feed port assembly to the tubular main body may also be apparent to those skilled in the art.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A bird feeder comprising:
a tubular main body having at least one opening;
at least one feeder port assembly, each of which is mountable within a respective one of the at least one opening, each of the at least one feeder port assembly comprising a main body part that projects into the tubular main body through the respective opening when the feeder port assembly is mounted within the respective opening; and
at least one magnet configured to magnetically secure, directly or indirectly, the at least one feeder port assembly to the tubular main body.

2. The bird feeder of claim 1 wherein the at least one opening comprises two opposing openings, and the at least one feeder port assembly comprises two feeder port assemblies that are mountable within the opposing openings, the two feeder port assemblies being magnetically interconnectable by at least one of the at least one magnet.

3. The bird feeder of claim 2 wherein the main body part of each of the two feeder port assemblies has an end, and the ends are arranged to abut against and interconnect to each other when the two feeder port assemblies are mounted within the opposing openings.

4. The bird feeder of claim 3 wherein at least one of the at least one magnet is located in the end of one of the main bodies of the two feeder port assemblies.

5. The bird feeder of claim 2 wherein the at least one magnet comprises two magnets, and each of the two magnets is arranged on a respective one of the two feeder port assemblies such that the two magnets attract each other when the two feeder port assemblies are mounted within the opposing openings.

6. The bird feeder of claim 2 wherein the two openings are diametrically opposed about the tubular main body.

7. The bird feeder of claim 1 wherein the at least one feeder port assembly comprises a plurality of substantially identical feeder port assemblies.

8. The bird feeder of claim 1 wherein each of the at least one feeder port assembly comprises a collar member defining a feed port opening, and, for each of the at least one feeder port assembly, the main body part extends from the collar member.

9. The bird feeder of claim 1 wherein each of the at least one feeder port assembly comprises a baffle member.

10. The bird feeder of claim 1 wherein the tubular main body is cylindrical.

11. The bird feeder of claim 1 wherein each of the at least one feeder port assembly further comprises a projecting perch.

12. The bird feeder of claim 1 further comprising at least one end cap assembly closing off at least one end of the tubular main body.

13. A bird feeder comprising:
a tubular main body having an end; and
a cap assembly that closes off the end of the tubular body, the cap assembly comprising a lid and at least one magnet magnetically connecting and at least partially securing the lid to the end of the tubular main body.

14. The bird feeder of claim 13 wherein at least one of the at least one magnet is mounted on the lid.

15. The bird feeder of claim 13 wherein the at least one magnet comprises a pair of corresponding magnets arranged to attract one another.

16. The bird feeder of claim 13 further comprising a hinge which hingedly connects the lid to the tubular main body.

17. The bird feeder of claim 13 wherein the lid is removably mounted to the end of the tubular main body.

18. The bird feeder of claim 13 wherein the cap assembly comprises a frame portion mounted to the tubular main body, and the lid is connected to the frame portion.

19. A perch assembly for a bird feeder, the perch assembly comprising:
a first projecting member having an attachment end attachable to the bird feeder such that the first member extends from the bird feeder when attached thereto;
a first perch member integral with the first projecting member disposed part way along the first projecting member and projecting therefrom at an angle thereto; and
a second perch member integral with the first projecting member and disposed at a location spaced from the first perch member along the first projecting member and projecting therefrom at an angle thereto;
wherein the first projecting member is angled from the attachment end such that when mounted to a bird feeder the first projecting member is angled and non perpendicular to the bird feeder and the first and second perch members are spaced both laterally and longitudinally from each other and the attachment end of the first projecting member.

20. The bird feeder of claim 1 further comprising the perch assembly of claim 19 attached to one of the at least one feeder port assembly.
